(19) United States
(12) Patent Application Publication
(10) Pub. No.: US 2024/0326023 A1
(43) Pub. Date: Oct. 3, 2024

(54) CATALYSTS FOR THE GENERATION OF GRAPHITIC NANOFIBERS AND CARBON MONOXIDE-FREE HYDROGEN

(71) Applicant: PACT FUEL, LLC, Darien, CT (US)

(72) Inventors: Juzer JANGBARWALA, Chino Hills, CA (US); Yinan JIN, Darien, CT (US)

(21) Appl. No.: 18/580,761

(22) PCT Filed: Jul. 26, 2022
(86) PCT No.: PCT/US2022/038373

§ 371 Date: Jan. 19, 2024

Related U.S. Application Data
(60) Provisional application No. 63/225,733, filed on Jul. 26, 2021.

(51) Int. Cl. B01J 23/78; B01J 37/12; B01J 37/18; C01B 3/26; C01B 32/05

(52) U.S. Cl. CPC B01J 23/78; B01J 37/12; B01J 37/18; C01B 3/26; C01B 32/05; C01B 2203/0277; C01B 2203/1058; C01B 2203/1241

(57) ABSTRACT

Catalyst compositions suitable for the generation of carbon monoxide-free hydrogen gas and graphitic nanofibers having consistent structure and dimension are disclosed, as are methods for making and using such catalyst compositions. The catalyst compositions are generally represented by the chemical formulae α_{w}Niₓβ_{y}O or αwNiₓβ_{y}γ_{z}O, where α is one or more elements of IUPAC group 13, β is one or more elements of IUPAC group 2, and ? is one or more elements of IUPAC group 11.

### CROSS-REFERENCE TO RELATED APPLICATION

This application claims the benefit of priority of U.S. Provisional Patent Application 63/225,733, filed 26 Jul. 2021, the entirety of which is incorporated herein by reference.

### FIELD

The present disclosure relates to catalyst compositions useful for commercial-scale catalytic decomposition of methane to generate solid carbon products and hydrogen gas, and methods for making and using such catalyst compositions.

### BACKGROUND

The thermal decomposition of methane to carbon and hydrogen gas, illustrated by reaction scheme (1) below, is a moderately endothermic process, but its energy requirement per mole of carbon produced (75.6 kJ/mol C) is considerably less than that required by steam methane reforming (SMR) processes (about 190 kJ/mol C). Thus, although SMR processes theoretically produce twice as many moles of hydrogen gas per mole of methane (four) compared to thermal decomposition (two), the energy associated with the process is disproportionately higher (37.8 kJ/mol H₂ for thermal decomposition vs. about 47.5 kJ/mol H₂ for SMR), and due to impurities and reaction byproducts, SMR processes more typically result in only about 3.5 moles H₂ per mole methane, still further increasing the energy requirements to about 54.3 kJ/mol H₂. Additionally, unlike in SMR processes, the hydrogen produced by thermal decomposition of methane can be produced in an oxygen-free environment and does not involve a water-gas shift reaction, and the reaction can therefore produce both high-purity carbon and a hydrogen gas stream that is free of carbon monoxide.

CH₄(g)+75.6kJ/mol→C(s)+2H₂(g) (1)

Thermal decomposition of natural gas has long been used to produce carbon black, with the resulting hydrogen gas being used as a supplementary fuel for the process. These processes are usually practiced in a semi-continuous fashion using two tandem reactors at high operational temperatures (typically about 1,400° C.), but those skilled in the art have attempted to reduce these operating temperatures via catalysis. Data on the catalytic decomposition of methane using cobalt-, chromium-, iron-, nickel-, platinum-, palladium-, and rhodium-based catalysts have been reported in the literature; see, e.g., Marina A. Ermakova et al., “Decomposition of methane over iron catalysts at the range of moderate temperatures: the influence of structure of the catalytic systems and the reaction conditions on the yield of carbon and morphology of carbon filaments,” 201(2) Journal of Catalysis 183 (July 2001), the entirety of which is incorporated herein by reference.

Directly catalyzed decomposition of methane offers two major advantages over thermal decomposition: (i) the operational temperature can be dramatically lowered, from about 1,400° C. to at least as low as about 550° C. (typically between about 550° C. and about 725° C.), thereby significantly reducing the energy input requirements of the process, and (ii) various engineered carbon nanostructures of high value can also be generated by the use of a carefully selected catalyst, thereby increasing the commercial value of the process. Because natural gas is widely available in large quantities, catalytic decomposition of methane to produce hydrogen gas and high-value carbon nanostructures on an industrial scale is technically feasible. However, for this decomposition process to be of practical, i.e., commercial and financial, significance, highly effective catalysts, which heretofore have been unavailable, are required. Such catalysts should exhibit high activity for a prolonged period of time and continue to function in the presence of high concentrations of accumulated carbon.

Additionally, catalytic decomposition of methane can be a capricious process due to exacting requirements for metal particle size and the tendency of the reaction conditions to have a detrimental effect on catalyst morphology. Previous work has shown that the highest yields of solid carbon are obtained where the average particle size of the catalyst is about 30 to 40 nm, but also that nickel catalyst particles may undesirably aggregate as soon as the catalyst comes into contact with methane; see, e.g., M. A. Ermakova et al., “XRD studies of evolution of catalytic nickel nanoparticles during synthesis of filamentous carbon from methane,” 62(2) Catalysis Letters 93 (Oct. 1999), the entirety of which is incorporated herein by reference. This particle sintering behavior results in a reduction of catalytic activity, but it is very difficult or impossible to operate catalytic methane decomposition processes on a commercial scale using particles as small as 30 to 40 nm; to be practical for industrial use, the catalyst particles would need to be at least an order of magnitude larger.

Thus, while the concept of generating carbon and hydrogen by catalyzed decomposition of methane has attracted intense interest and demonstrated technical feasibility, consistent production of a desired high-quality carbonaceous product on a commercial scale has been difficult to achieve. Particularly, in addition to the catalyst particle size limitations discussed above, many previous approaches in the art have failed to provide any degree of control over the type of carbon nanomaterials produced, and as a result the carbonaceous products of these approaches must be purified by chemical and physical processes that are typically difficult, expensive, and/or time-consuming, making them impractical for commercial applications. For example, while the use of NiMgO and NiMgCuO catalysts to produce carbon nanofibers has long been known in the art (see, e.g., U.S. Pat. Nos. 6,995,115 and 7,001,586 to Wang et al., the entireties of both of which are incorporated herein by reference), these catalysts produce inconsistent mixes of nanomaterials along with amorphous carbon powders; the former are difficult to separate/purify, and the latter have very limited commercial value.

There is thus a need in the art for catalyst compositions for use in methane decomposition processes that improve the performance of these processes by enabling the production of a selected carbon nanomaterial of high quality and/or high purity.

### SUMMARY

In an aspect of the present disclosure, a catalyst composition is represented by the generalized chemical formula α_{w}Niₓβ_{y}O, wherein α is at least one element selected from the group consisting of boron (B), aluminum (Al), gallium (Ga), indium (In), thallium (Tl), and combinations thereof, β is at least one element selected from the group consisting of beryllium (Be), magnesium (Mg), calcium (Ca), strontium (Sr), barium (Ba), and combinations thereof, a ratio of x:y is at least about 1.0 and no more than about 6.2, and at least about 25% of active nickel sites in the catalyst composition are in a metallic state.

In embodiments, a may be aluminum (Al).

In embodiments, p may be magnesium (Mg).

In embodiments, a ratio of w:x may be at least about 0.1 and no more than about 0.5.

In embodiments, the ratio of x:y may be at least about 1.8 and no more than about 2.8.

In embodiments, at least about 50% of active nickel sites in the catalyst composition may be in the metallic state.

In another aspect of the present disclosure, a catalyst composition is represented by the generalized chemical formula α_{w}Niₓβ_{y}γ_{z}O, wherein α is at least one element selected from the group consisting of boron (B), aluminum (Al), gallium (Ga), indium (In), thallium (Tl), and combinations thereof, β is at least one element selected from the group consisting of beryllium (Be), magnesium (Mg), calcium (Ca), strontium (Sr), barium (Ba), and combinations thereof, γ is at least one element selected from the group consisting of copper (Cu), silver (Ag), gold (Au), and combinations thereof, a ratio of x:y is at least about 1.3 and no more than about 3.6, a ratio of x:z is at least about 1.0 and no more than about 19.0, and at least about 25% of active nickel sites in the catalyst composition are in a metallic state.

In embodiments, α may be aluminum (Al).

In embodiments, β may be magnesium (Mg).

In embodiments, γ may be copper (Cu).

In embodiments, a ratio of w:x may be at least about 0.1 and no more than about 0.5.

In embodiments, the ratio of x:y may be at least about 1.8 and no more than about 2.8.

In embodiments, the ratio of x:z may be at least about 2.3 and no more than about 9.0.

In embodiments, at least about 50% of active nickel sites in the catalyst composition may be in the metallic state.

In embodiments, at least about 25% of active sites of the γ element(s) in the catalyst composition may be in a metallic state. At least about 50% of active sites of the γ element(s) in the catalyst composition may, but need not, be in the metallic state.

In another aspect of the present disclosure, a method for manufacturing a catalyst composition comprises (a) providing a catalyst precursor composition comprising w parts by mole of one or more α elements, x parts by mole of nickel, and y parts by mole of one or more β elements, wherein the one or more α elements are selected from the group consisting of boron (B), aluminum (Al), gallium (Ga), indium (In), and thallium (Tl); the one or more R elements are selected from the group consisting of beryllium (Be), magnesium (Mg), calcium (Ca), strontium (Sr), and barium (Ba); and a ratio of x:y is at least about 1.0 and no more than about 6.2; (b) calcining the catalyst precursor composition at a temperature of at least about 500° C. and no more than about 1,000° C. to form a calcine; and (c) reducing the calcine under an atmosphere comprising hydrogen gas at a temperature of at least about 600° C. and no more than about 1,000° C. to form the catalyst composition.

In embodiments, the one or more α elements may comprise, or consist of, aluminum (Al).

In embodiments, the one or more β elements may comprise, or consist of, magnesium (Mg).

In embodiments, a ratio of w:x may be at least about 0.1 and no more than about 0.5.

In embodiments, the ratio of x:y may be at least about 1.8 and no more than about 2.8.

In embodiments, after step (c), at least about 50% of active nickel sites in the catalyst composition may be in a metallic state.

In embodiments, the catalyst precursor composition may further comprise z parts by mole of one or more γ elements, wherein the one or more γ elements are selected from the group consisting of copper (Cu), silver (Ag), and gold (Au); the ratio of x:y is at least about 1.3 and no more than about 3.6; and a ratio of x:z is at least about 1.0 and no more than about 19.0.

In embodiments, the one or more γ elements may comprise, or consist of, copper (Cu).

In embodiments, the ratio of x:z may be at least about 2.3 and no more than about 9.0.

In embodiments, after step (c), at least about 25% of active sites of the one or more γ elements in the catalyst composition may be in a metallic state. After step (c), at least about 50% of active sites of the one or more γ elements in the catalyst composition may, but need not, be in the metallic state.

In embodiments, the temperature in step (b) may be at least about 600° C. and no more than about 900° C. The temperature in step (b) may, but need not, be at least about 750° C. and no more than about 850° C.

In embodiments, the atmosphere in step (c) may further comprise argon.

In embodiments, the temperature in step (c) may be at least about 850° C. and no more than about 950° C.

In another aspect of the present disclosure, a method for catalytic decomposition of methane to produce elemental carbon solids and a product stream comprising hydrogen gas comprises (a) providing a catalyst composition represented by the generalized chemical formulae α_{w}Niₓβ_{y}O or α_{w}Niₓβ_{y}γ_{z}O, wherein α is at least one element selected from the group consisting of boron (B), aluminum (Al), gallium (Ga), indium (In), thallium (Tl), and combinations thereof, β is at least one element selected from the group consisting of beryllium (Be), magnesium (Mg), calcium (Ca), strontium (Sr), barium (Ba), and combinations thereof, γ is at least one element selected from the group consisting of copper (Cu), silver (Ag), gold (Au), and combinations thereof, a ratio of x:y is at least about 1.0 and no more than about 6.2, a ratio of x:z, when γ is present, is at least about 1.0 and no more than about 19.0, and at least about 25% of active nickel sites in the catalyst composition are in a metallic state; and (b) contacting, at a temperature of at least about 500° C. and no more than about 800° C., the catalyst composition with a reactant gas stream comprising methane gas.

In embodiments, α may be aluminum (Al).

In embodiments, β may be magnesium (Mg).

In embodiments, γ may be copper (Cu).

In embodiments, a ratio of w:x may be at least about 0.1 and no more than about 0.5.

In embodiments, the ratio of x:y may be at least about 1.8 and no more than about 2.8.

In embodiments, the ratio of x:z, when γ is present, may be at least about 2.3 and no more than about 9.0.

In embodiments, at least about 50% of active nickel sites in the catalyst composition may be in the metallic state.

In embodiments, at least about 25% of active sites of the γ element(s) in the catalyst composition are in a metallic state. At least about 50% of active sites of the γ element(s) in the catalyst composition may, but need not, be in the metallic state.

In embodiments, at least about 85% by mass of the carbon solids may be formed as graphitic nanofibers comprising platelets aligned perpendicular to a fiber axis.

In embodiments, the product stream may be free of carbon monoxide.

In embodiments, the reactant gas stream may comprise at least about 99.9 vol % methane.

In embodiments, the reactant gas stream may further comprise at least about 5 vol % and no more than about 50 vol % hydrogen gas.

In embodiments, the reactant gas stream may further comprise carbon dioxide. The reactant gas stream may, but need not, be a stream of biogas or purified biogas.

In embodiments, the temperature in step (b) may be at least about 600° C. and no more than about 750° C. The temperature in step (b) may, but need not, be at least about 650° C. and no more than about 725° C.

In embodiments, step (b) may be performed in a suspended bed reactor.

In embodiments, at least a portion of the elemental carbon solids may form on surfaces of particles of the catalyst composition.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

As used herein, unless otherwise specified, the term “biogas” refers to a mixture of gases, including at least methane and carbon dioxide, produced by anaerobic digestion of organic substrates by anaerobic and/or methanogenic organisms. Biogases, as that term is used herein, typically (but not always) further include hydrogen sulfide, siloxanes, or other sulfur compounds when first produced; the term “purified biogas,” as used herein unless otherwise specified, refers to biogas that has been treated to remove at least a portion of the sulfur compounds therefrom.

### Catalyst Compositions

The present disclosure provides catalyst compositions that are useful to catalyze the decomposition of methane to solid carbon structures and hydrogen gas, and even more particularly to produce highly selective and/or pure carbon solids having a selected dimension, morphology, and/or structure (e.g., graphitic nanofibers) and a carbon monoxide-free hydrogen gas product. Stated slightly differently, the catalyst compositions according to the present disclosure provide a pathway for the mass (commercial-scale) production of specific types of carbon nanofibers that consist primarily or entirely of crystalline graphite (e.g., platelet-type carbon nanofibers, in which the nanofibers comprise platelets that are aligned perpendicular to a major axis of the nanofiber) via catalytic methane decomposition, which has not heretofore been achieved.

The catalyst compositions according to the present disclosure can be represented by the generalized chemical formulae α_{w}Niₓβ_{y}O or α_{w}Niₓβ_{y}γ_{z}O, where α is one or more elements of IUPAC group 13 (i.e., boron, aluminum, gallium, indium, and/or thallium), β is one or more elements of IUPAC group 2 (i.e., beryllium, magnesium, calcium, strontium, and/or barium), and γ is one or more elements of IUPAC group 11 (i.e., copper, silver, and/or gold). Most typically, but not exclusively, α consists primarily or entirely of aluminum, β consists primarily or entirely of magnesium, and γ (where present) consists primarily or entirely of copper. It is to be expressly understood that in any composition according to the present disclosure in which any one or more of α, β, or γ consists of two or more elements, the corresponding stoichiometric subscript in the generalized chemical formulae given above represents the combined amounts of the two or more elements; by way of non-limiting example, in a composition represented by the formula AlNi₅MgCaO, the stoichiometric subscript y is equal to 2 because each mole of the composition contains two moles of group 2 elements (one mole of magnesium and one mole of calcium) as β, and in a composition represented by the formula Al₂N₁₈Mg₄CuAgO, the stoichiometric subscript z is equal to 2 because each mole of the composition contains two moles of group 11 elements (one mole of copper and one mole of silver) as γ.

In previous work, among all catalysts investigated for use in the catalytic decomposition of methane, nickel-based catalysts appeared to provide the highest activity and have been the catalysts most frequently used. When in its metallic (i.e., non-ionized) state, nickel forms a face-centered cubic (FCC) crystal system. Without wishing to be bound by any particular theory, the present inventors hypothesize that the catalyst compositions of the present disclosure catalyze the decomposition of methane to solid carbon and hydrogen gas by chemisorbing methane gas molecules onto a (100) and/or (111) face of an FCC nickel crystal, where the decomposition reaction occurs. Thus, in catalyst compositions of the present disclosure, it is preferable for at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95% of active nickel sites to be in the metallic state, to increase the number of FCC nickel crystal faces available for chemisorption and decomposition of methane molecules.

Again without wishing to be bound by any particular theory, the present inventors hypothesize that the α element(s) (e.g., aluminum, etc.), β element(s) (e.g., magnesium, etc.), and (where present) γ elements (e.g., copper, etc.) in the catalyst compositions of the present disclosure act as activators, promoters, or other species that exert a beneficial effect on the manufacture or use of the catalyst compositions. By way of first non-limiting example, the present inventors hypothesize that the α element(s) (e.g., aluminum, etc.) may at least partially control the formation and growth of solid carbon nanostructures resulting from the decomposition of methane, and that as a result, those skilled in the art, based on the teachings of the present disclosure, may be able to select a desired relative amount of a element(s) in the compositions to control, optimize, select, and/or tune the dimension, morphology, and/or structure of the carbon solids (e.g., nanofibers, nanotubes, etc.) with a high degree of purity and/or specificity. By way of second non-limiting example, the present inventors hypothesize that the β element(s) (e.g., magnesium, etc.) may act to stabilize FCC nickel crystals or otherwise maintain the nickel in the metallic state, thereby reducing the extent of calcination required during manufacture of the catalyst composition and/or improving the catalytic activity of the catalyst composition by increasing the proportion of active nickel sites present in the metallic state (i.e., as FCC crystals). By way of third non-limiting example, the present inventors hypothesize that the γ element(s) (e.g., copper, etc.), where present, may allow the operating temperature of the methane decomposition process to be reduced by at least as much as about 50° C.; like nickel, the stable group 11 elements (copper, silver, and gold) form FCC crystals when in a metallic state, and it may therefore, in some embodiments, be preferable for at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95% of active sites of the γ element(s) to be in the metallic state.

In many embodiments of the present disclosure, α may consist primarily or entirely of aluminum. However, it is to be expressly understood that any one or more other elements from the same column of the periodic table, i.e., IUPAC group 13 (sometimes known as the “boron group”), such as boron, gallium, indium, and/or thallium, may make up at least a portion, and in some embodiments the entirety of, the α element(s) of catalyst compositions according to the present disclosure. Without wishing to be bound by any particular theory, the present inventors hypothesize that other IUPAC group 13 elements, e.g., boron, gallium, indium, and/or thallium, can serve the same or similar functions as aluminum in the catalyst compositions of the present disclosure, e.g., at least partially controlling the formation and growth of solid carbon nanostructures resulting from the decomposition of methane.

In many embodiments of the present disclosure, β may consist primarily or entirely of magnesium. However, it is to be expressly understood that any one or more elements from the same column of the periodic table, i.e., IUPAC group 2 (the alkaline earth metals), such as beryllium, calcium, strontium, and/or barium, may make up at least a portion, and in some embodiments the entirety of, the β elements of catalyst compositions according to the present disclosure. Without wishing to be bound by any particular theory, the present inventors hypothesize that other IUPAC group 2 elements, e.g., beryllium, calcium, strontium, and/or thallium, can serve the same or similar functions as magnesium in the catalyst compositions of the present disclosure, e.g., acting to stabilize FCC nickel crystals or otherwise maintain the nickel in the metallic state.

In many embodiments of the present disclosure, γ, where present, may consist primarily or entirely of copper. However, it is to be expressly understood that any one or more elements from the same column of the periodic table, i.e., IUPAC group 11, such as silver and/or gold, may make up at least a portion, and in some embodiments the entirety of, the γ elements of catalyst compositions according to the present disclosure. Without wishing to be bound by any particular theory, the present inventors hypothesize that other IUPAC group 11 elements, e.g., silver and/or gold, can serve the same or similar functions as copper in the catalyst compositions of the present disclosure, e.g., allowing the operating temperature of the methane decomposition process to be reduced by at least as much as about 50° C.

The present inventors have generally found that one important parameter for controlling the type of carbon structure that is formed by methane decomposition using the catalyst compositions of the present disclosure is the molar ratio of α element(s) to nickel, i.e., a ratio of w:x in the generalized chemical formulae α_{w}Niₓβ_{y}O or α_{w}Niₓβ_{y}γ_{z}O. Most preferably, this ratio (or, in other words, the number of moles of α element atoms per mole of nickel atoms in the catalyst composition) is at least about 0.1 and no more than about 0.5; by way of non-limiting example, this ratio may be about 0.10, about 0.11, about 0.12, about 0.13, about 0.14, about 0.15, about 0.16, about 0.17, about 0.18, about 0.19, about 0.20, about 0.21, about 0.22, about 0.23, about 0.24, about 0.25, about 0.26, about 0.27, about 0.28, about 0.29, about 0.30, about 0.31, about 0.32, about 0.33, about 0.34, about 0.35, about 0.36, about 0.37, about 0.38, about 0.39, about 0.40, about 0.41, about 0.42, about 0.43, about 0.44, about 0.45, about 0.46, about 0.47, about 0.48, about 0.49, or about 0.50, or alternatively may be any value in any subrange lying between any two of these values.

The present inventors have generally found that another important parameter for maximizing the catalytic activity of the catalyst composition, and thus maximizing the yield of solid carbon product and hydrogen gas in methane decomposition processes utilizing the catalyst, is the molar ratio of nickel to β elements, i.e. a ratio of x:y in the generalized chemical formulae α_{w}Niₓβ_{y}O or α_{w}Niₓβ_{y}γ_{z}O. Most preferably, this ratio (or, in other words, the number of moles of nickel atoms per mole of β element atoms in the catalyst composition) is at least about 1.0 and no more than about 6.2; by way of non-limiting example, this ratio may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, or about 6.2, or alternatively may be any value in any subrange lying between any two of these values. In general, and without wishing to be bound by any particular theory, the present inventors have found that when the ratio of x:y is in a range from about 1.0 to about 6.2, the yield of solid carbon product and hydrogen gas in methane decomposition processes utilizing the catalyst is high enough for the process to have commercial feasibility. More particularly, in some embodiments, the yield of solid carbon product and hydrogen gas may be maximized when the ratio of x:y is at least about 1.8 and no more than about 2.8, or alternatively is about 1.8, about 1.9, about 2.0, about 2.1, about 2.2, about 2.3, about 2.4, about 2.5, about 2.6, about 2.7, about 2.8, or any value in any subrange lying between any two of these values. Additionally or alternatively, in embodiments in which 7 elements are included, i.e., the catalyst composition is represented by the generalized chemical formula α_{w}Niₓβ_{y}γ_{z}O, the ratio of x:y may preferably be at least about 1.3 and no more than about 3.6; by way of non-limiting example, this ratio may, in embodiments, be about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, or about 3.6, or alternatively may be any value in any subrange lying between any two of these values.

The present inventors have generally found that, in embodiments in which the catalyst composition is represented by the generalized chemical formula α_{w}Niₓβ_{y}γ_{z}O, another important parameter for further reducing the operating temperatures at which methane decomposition occurs is the molar ratio of nickel to γ elements, i.e., a ratio of x:z in the generalized chemical formula α_{w}Niₓβ_{y}γ_{z}O. Most preferably, this ratio (or, in other words, the number of moles of nickel atoms per mole of γ element atoms in the catalyst composition) is at least about 1.0 and no more than about 19.0; by way of non-limiting example, this ratio may be about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0, about 9.5, about 10.0, about 10.5, about 11.0, about 11.5, about 12.0, about 12.5, about 13.0, about 13.5, about 14.0, about 14.5, about 15.0, about 15.5, about 16.0, about 16.5, about 17.0, about 17.5, about 18.0, about 18.5, or about 19.0, or alternatively may be any value in any subrange lying between any two of these values. In general, and without wishing to be bound by any particular theory, the present inventors have found that when the ratio of x:z is in a range from about 1.0 to about 19.0, the operating temperature needed to induce decomposition of methane may be reduced by at least as much about as 50° C. More particularly, in some embodiments, operating temperature may be optimized when the ratio of x:z is at least about 2.3 and no more than about 9.0, or alternatively is about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, about 8.0, about 8.1, about 8.2, about 8.3, about 8.4, about 8.5, about 8.6, about 8.7, about 8.8, about 8.9, or about 9.0, or alternatively may be any value in any subrange lying between any two of these values.

Parameters relating to the chemical composition and physical structure of the catalyst may be controlled, designed, optimized, selected, and/or tuned to provide desired characteristics of the methane decomposition process in which the catalyst composition is used, as described in greater detail throughout this disclosure. One important parameter of catalyst compositions suitable for use in the methods and systems of the present disclosure is the effective surface area of the catalyst, i.e., the total surface area of the catalyst that is, or can be, in direct contact with methane. The total surface area of solid catalyst particles has an important effect on reaction rate, and in general, for a given mass of catalyst, the smaller the catalyst particle size, the larger the effective surface area.

Another important parameter of catalyst compositions suitable for use in the methods and systems of the present disclosure is the diffusion profile of the catalyst composition. The diffusion profile is, in turn, generally controlled by the total porosity and pore size of the catalyst particles themselves, which dictates the degree to which reactant molecules (i.e., methane molecules) can diffuse into and through the catalyst particles. In embodiments, the pore sizes of catalyst particles may range as from as small as about 4 Å (0.4 nm) to as large as about 1,500 μm, or alternatively in any range having a lower bound of any whole number of angstroms from 4 Å to 1,500 μm and an upper bound of any other whole number of angstroms from 4 Å to 1,500 μm.

Skilled artisans, in view of the above considerations, can select and optimize an appropriate material and geometry of the catalyst composition. This selection, as skilled artisans will appreciate in view of the present disclosure, is motivated by the desired kinetics of the methane decomposition reaction.

### Methods for Making Catalyst Compositions

An aspect of the present disclosure is a method for producing a catalyst composition useful in methane decomposition processes. One advantage and benefit of the catalyst compositions of the present disclosure is that they may be manufactured relatively easily, inexpensively, and quickly, using readily available reactants. In embodiments of the present disclosure, α method for manufacturing a catalyst composition as disclosed herein begins by providing a solution or slurry of a hydroxide of the β element(s); by way of non-limiting example, where β is magnesium, magnesium hydroxide slurries are widely available in large quantities, due to their widespread use in municipal and industrial wastewater treatment systems. Subsequently, salts of the other non-oxygen elements of the catalyst compositions, i.e., nickel, α element(s) (e.g., aluminum, etc.), and in some embodiments γ element(s) (e.g., copper, etc.), either in bulk/solid form or in a solution of a suitable solvent (as those of ordinary skill in the art will understand and appreciate how to select), may be added to, mixed with, or dissolved in this slurry; suitable salts include chloride, nitrate, and sulfate salts of the desired elements, and in many embodiments the most preferable salts may be those (e.g., aluminum chloride) from which the anions will readily vaporize upon subsequent heating. Thus, in one non-limiting exemplary embodiment, salts of nickel (e.g., nickel chloride and/or nitrate), aluminum (e.g., aluminum sulfate and/or chloride), and copper (e.g., copper chloride and/or nitrate) are mixed into a magnesium hydroxide slurry to form a catalyst precursor. As those skilled in the art will appreciate, the relative stoichiometric amounts of nickel, α element, β element, and (where present) γ element salts can easily be selected at this stage to provide appropriate ratios between any two or more of w, x, y, and z in the finished catalyst composition. The catalyst precursor solution, slurry, and/or mixture is then calcined at an appropriate temperature (in some embodiments, between about 500° C. and about 1,000° C., typically between about 600° C. and about 900° C., and more typically between about 750° C. and about 850° C.) under an appropriate environment (e.g., air, hydrogen gas, nitrogen gas, argon, sulfur dioxide, nitrogen oxide, nitrogen dioxide, or a combination thereof) for a time (in some embodiments, between about 1 hour and about 30 hours, most typically about 24 hours) sufficient to vaporize substantially all of the anions present and convert at least a portion of the nickel, and in some embodiments at least a portion of any one or more of the α element(s), β element(s), and (where present) γ element(s), to a metallic state, as described elsewhere throughout this disclosure. Upon completion of the calcination, the metals of the catalyst composition will readily oxidize when exposed to air; thus, as a final step, the calcine is reduced under a reducing atmosphere (typically hydrogen gas, or a mixture of hydrogen gas with an inert gas, e.g., argon) at an appropriate temperature (typically between about 600° C. and about 1,000° C., and most typically between about 850° C. and about 950° C.) for a time sufficient to cause the nickel, α element(s), β element(s), and (where present) γ element(s) to merge into a single phase and form a composition represented by the generalized chemical formulae α_{w}Niₓβ_{y}O or α_{w}Niₓβ_{y}γ_{z}O. In some embodiments in which the reducing environment includes hydrogen gas, at least a portion of this hydrogen gas may be recycled from a downstream process unit in which previously produced catalyst composition is used to decompose methane to solid carbon products and a carbon monoxide-free hydrogen gas stream.

### Methods for Catalytic Methane Decomposition

Another aspect of the present disclosure is a method for producing solid carbon products (particularly, in many embodiments, solid carbon products having a defined or selected dimension, morphology, and/or structure, e.g., carbon nanofibers or nanotubes, with a high degree of selectivity/purity) and hydrogen gas (particularly, in many embodiments, a carbon monoxide-free hydrogen gas stream) by the catalyzed decomposition of methane, utilizing a catalyst composition as disclosed herein. In embodiments of this method, a catalyst composition represented by the generalized chemical formulae α_{w}Niₓβ_{y}O or α_{w}Niₓβ_{y}γ_{z}O is provided. This catalyst composition is then contacted with methane gas, whereupon at least a portion of the methane gas decomposes to form a solid carbon product and hydrogen gas. In some embodiments, the solid carbon product may form in direct contact with (e.g., grow on a surface of) particles of the catalyst composition. In some embodiments, at least a portion of one or both of the solid carbon products and the hydrogen gas can be further reacted to form a product of interest downstream; additionally or alternatively, as described above, at least a portion of the hydrogen gas may be recycled for use as a component of a reducing atmosphere in synthesizing the catalyst composition.

Most typically, methane used in the methods according to the present disclosure may be provided as a component of a stream of natural gas, but it is to be expressly understood that the methane can be derived from any natural or artificial source of methane. The methane gas stream can contain one or more other gases, e.g., hydrogen gas, carbon dioxide, nitrogen dioxide, nitrogen oxide, water, or other hydrocarbons (e.g., ethane, propane, butane, etc.); in some embodiments, the methane stream may be a biogas or purified biogas stream. The catalyst composition selectively decomposes the methane and does not react with other gases in the gas stream.

Methods for the catalytic decomposition of methane according to the present disclosure are carried out at temperatures of between about 500° C. and about 800° C., typically between about 600° C. and 750° C. and more typically between about 650° C. and about 725° C.; these operating temperatures represent a significant reduction from the temperatures required for purely thermal decomposition of methane (about 1,400° C.) and are thus advantageous in that they require significantly less energy input. The catalytic methane decomposition methods of the present disclosure may be carried out at operating pressures of between about 0.05 kPa and about 500 kPa, a range that includes ambient and/or atmospheric pressures; in some embodiments, these operating pressures may be total (absolute) pressures, while in other embodiments they may be the partial pressure of methane present in the gas stream (where the gas stream contains other gases in addition to methane). The catalyst composition is generally provided in unstructured form (i.e., as a “bulk” or “free” material not affixed to any structure or substrate). The methane decomposition can be carried out in any suitable type of reactor, including but not necessarily limited to a suspended bed reactor in which the methane gas stream flows over and/or through a suspended bed of the catalyst.

One advantage of the catalytic methane decomposition methods according to the present disclosure is that they may be useful for greenhouse gas capture and/or reduction of greenhouse gas emissions. Particularly, whereas previous approaches to the capture or reduction of methane emissions and subsequent decomposition of the methane to carbon solids and hydrogen gas have suffered from high cost and/or safety or purity concerns (e.g., the presence of carbon monoxide or other hazardous species in the hydrogen gas stream and/or poor control over the structure of the resulting carbon solids), the methane decomposition methods of the present disclosure provide high-value, high-purity products with fewer safety and toxicity concerns, i.e., a desired highly specific/pure solid carbon structure and a carbon monoxide-free hydrogen gas stream. The catalytic decomposition methods disclosed herein may thus represent a more financially and environmentally attractive avenue for capturing, reducing, and/or mitigating methane emissions than have previously been known in the art.

The invention is further described by way of the following non-limiting Examples.

### Example 1

### Effect of Catalyst Composition on Carbon Nanofiber Yield and Morphology

Pre-catalyst calcines were made by combining chloride and/or nitrate salts of aluminum, nickel, and magnesium to form a precursor mixture and calcining this precursor mixture at 500° C. in air. For each of several experimental runs, relative amounts of the nickel and magnesium salts were selected to provide varying molar ratios of nickel to magnesium (i.e., a desired ratio of x:y) in the pre-catalyst calcine, and thus in the finished catalyst composition.

For each of the experimental runs, one of the pre-catalyst calcines thus produced was placed in a quartz flow reactor heated by a Lindberg horizontal tube furnace; specifically, a 50 mg sample of powdered calcine was placed in a ceramic “sponge” made with alumina fibers at the center of the reactor tube in the furnace. The system was flushed with argon for 30 minutes, and the final Al_{w}NiₓMg_{y}O catalyst was then made by reducing the calcine at 850° C. under an environment of 10 vol % H₂/90 vol % argon, after which the system was again flushed with argon. Methane was then introduced into the reactor and allowed to react in the presence of the catalyst at an operating temperature of 550 to 750° C. and ambient (atmospheric) pressure; the flow rate of methane gas was precisely monitored and regulated (60 mL/min) by the use of MKS mass flow controllers to allow a constant composition of feed gas to be delivered. The hot feed gas thus flowed through the alumina “sponge” and “lifted” the catalyst into a fluidized state. Progress of the reaction was monitored by sampling the inlet and outlet gases at regular intervals and analyzing the reactants and products by gas chromatography; the flow of methane and the operating temperatures of 550 to 750° C. were maintained until complete deactivation of the catalyst was observed (i.e., gas chromatography indicated no H₂ in the outlet gas). The reaction resulted in the deposition of carbon solids, the yield of which was determined gravimetrically after the system cooled to room temperature. The solid carbon product was also examined to determine the proportion of the solids (by mass) that were produced as platelet-type nanofibers, an especially desirable type of carbon nanostructure. The nickel/magnesium molar ratio (i.e., a ratio of x:y in the generalized chemical formula Al_{w}NiₓMg_{y}O), yield of solid carbon (per mass of pre-reduction calcine), yield of hydrogen gas (per mass of pre-reduction calcine), and proportion of carbon solids produced as platelet-type nanofibers, for each experimental run, are given in Table 1.

TABLE 1

| | | | Platelet-type |
|---|---|---|---|
| | Solid carbon yield | Hydrogen yield | nanofiber yield |
| x:y ratio | (g C/g calcine) | (L H₂/g calcine) | (wt %) |
| 0.6 | 19 | 70 | 95 |
| 1.0 | 39 | 147 | 95 |
| 1.3 | 93 | 347 | 93 |
| 1.8 | 128 | 477 | 92 |
| 2.0 | 138 | 513 | 87 |
| 2.4 | 165 | 616 | 98 |
| 2.8 | 135 | 504 | 93 |
| 3.6 | 114 | 426 | 91 |

### Example 2

### Effect of Reduction Temperature on Catalyst Performance

The procedure of Example 1 was repeated, except that the x:y ratio was held constant at 2.4 and the temperature of the hydrogen/argon reduction step was varied between 600° C. and 1,000° C. The flow of methane and a reactor temperature of 550 to 750° C. were maintained until the conversion of methane (measured by gas chromatography of the outlet gases) decreased to less than 4%. The catalyst was also examined by X-ray crystallography to determine the proportion of nickel atoms in the metallic (i.e., non-ionized or Ni⁰) state. The reduction temperature, percentage of methane converted (after 1 hour), catalyst lifetime, yields of hydrogen gas and solid carbon (per mass of pre-reduction calcine), and proportion of carbon solids produced as platelet-type nanofibers, for each experimental run, are given in Table 2.

TABLE 2

| Reduction | CH₄ | Catalyst | | | Ni⁰ |
|---|---|---|---|---|---|
| temp. | conversion | lifetime | H₂ yield | Carbon yield | (% of |
| (° C.) | (%) | (hr) | (L/g calcine) | (g/g calcine) | total Ni) |
| 600 | 17.1 | 12 | 201 | 54 | 14.5 |
| 750 | 18.1 | 21 | 386 | 103 | 56.9 |
| 850 | 17.2 | 30 | 616 | 165 | 69.3 |
| 950 | 17.6 | 31 | 607 | 162 | 74.0 |
| 1000 | 15.1 | 14 | 213 | 57 | 78.0 |

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure.

The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A catalyst composition represented by the generalized chemical formula α_{w}Niₓβ_{y}O, wherein:
α is at least one element selected from the group consisting of boron (B), aluminum (Al), gallium (Ga), indium (In), thallium (Tl), and combinations thereof,
β is at least one element selected from the group consisting of beryllium (Be), magnesium (Mg), calcium (Ca), strontium (Sr), barium (Ba), and combinations thereof,
a ratio of x:y is at least about 1.0 and no more than about 6.2, and
at least about 25% of active nickel sites in the catalyst composition are in a metallic state.

2. The catalyst composition of claim 1, wherein α is aluminum (Al).

3. The catalyst composition of claim 1, wherein β is magnesium (Mg).

4. The catalyst composition of claim 1, wherein a ratio of w:x is at least about 0.1 and no more than about 0.5.

5. The catalyst composition of claim 1, wherein the ratio of x:y is at least about 1.8 and no more than about 2.8.

6. The catalyst composition of claim 1, wherein at least about 50% of active nickel sites in the catalyst composition are in the metallic state.

7. A catalyst composition represented by the generalized chemical formula α_{w}Niₓβ_{y}γ_{z}O, wherein:
α is at least one element selected from the group consisting of boron (B), aluminum (Al), gallium (Ga), indium (In), thallium (Tl), and combinations thereof,
β is at least one element selected from the group consisting of beryllium (Be), magnesium (Mg), calcium (Ca), strontium (Sr), barium (Ba), and combinations thereof,
γ is at least one element selected from the group consisting of copper (Cu), silver (Ag), gold (Au), and combinations thereof,
a ratio of x:y is at least about 1.3 and no more than about 3.6,
a ratio of x:z is at least about 1.0 and no more than about 19.0, and
at least about 25% of active nickel sites in the catalyst composition are in a metallic state.

8. The catalyst composition of claim 7, wherein α is aluminum (Al).

9. The catalyst composition of claim 7, wherein β is magnesium (Mg).

10. The catalyst composition of claim 7, wherein γ is copper (Cu).

11. The catalyst composition of claim 7, wherein a ratio of w:x is at least about 0.1 and no more than about 0.5.

12. The catalyst composition of claim 7, wherein the ratio of x:y is at least about 1.8 and no more than about 2.8.

13. The catalyst composition of claim 7, wherein the ratio of x:z is at least about 2.3 and no more than about 9.0.

14. The catalyst composition of claim 7, wherein at least about 50% of active nickel sites in the catalyst composition are in the metallic state.

15. The catalyst composition of claim 7, wherein at least about 25% of active sites of the γ element(s) in the catalyst composition are in a metallic state.

16. The catalyst composition of claim 15, wherein at least about 50% of active sites of the γ element(s) in the catalyst composition are in the metallic state.

17. A method for manufacturing a catalyst composition, comprising:
(a) providing a catalyst precursor composition comprising w parts by mole of one or more α elements, x parts by mole of nickel, and y parts by mole of one or more β elements, wherein:
the one or more α elements are selected from the group consisting of boron (B), aluminum (Al), gallium (Ga), indium (In), and thallium (Tl);
the one or more β elements are selected from the group consisting of beryllium (Be), magnesium (Mg), calcium (Ca), strontium (Sr), and barium (Ba); and
a ratio of x:y is at least about 1.0 and no more than about 6.2;
(b) calcining the catalyst precursor composition at a temperature of at least about 500° C. and no more than about 1,000° C. to form a calcine; and
(c) reducing the calcine under an atmosphere comprising hydrogen gas at a temperature of at least about 600° C. and no more than about 1,000° C. to form the catalyst composition.

18. The method of claim 17, wherein the one or more α elements comprise, or consist of, aluminum (Al).

19. The method of claim 17, wherein the one or more β elements comprise, or consist of, magnesium (Mg).

20. The method of claim 17, wherein a ratio of w:x is at least about 0.1 and no more than about 0.5.

21. The method of claim 17, wherein the ratio of x:y is at least about 1.8 and no more than about 2.8.

22. The method of claim 17, wherein, after step (c), at least about 50% of active nickel sites in the catalyst composition are in a metallic state.

23. The method of claim 17, wherein:
the catalyst precursor composition further comprises z parts by mole of one or more γ elements, wherein the one or more γ elements are selected from the group consisting of copper (Cu), silver (Ag), and gold (Au);
the ratio of x:y is at least about 1.3 and no more than about 3.6; and
a ratio of x:z is at least about 1.0 and no more than about 19.0.

24. The method of claim 23, wherein the one or more γ elements comprise, or consist of, copper (Cu).

25. The method of claim 23, wherein the ratio of x:z is at least about 2.3 and no more than about 9.0.

26. The method of claim 23, wherein, after step (c), at least about 25% of active sites of the one or more γ elements in the catalyst composition are in a metallic state.

27. The method of claim 26, wherein, after step (c), at least about 50% of active sites of the one or more γ elements in the catalyst composition are in the metallic state.

28. The method of claim 23, wherein the temperature in step (b) is at least about 600° C. and no more than about 900° C.

29. The method of claim 28, wherein the temperature in step (b) is at least about 750° C. and no more than about 850° C.

30. The method of claim 23, wherein the atmosphere in step (c) further comprises argon.

31. The method of claim 23, wherein the temperature in step (c) is at least about 850° C. and no more than about 950° C.

32. A method for catalytic decomposition of methane to produce elemental carbon solids and a product stream comprising hydrogen gas, comprising:
(a) providing a catalyst composition represented by the generalized chemical formulae α_{w}Niₓβ_{y}O or α_{w}Niₓβ_{y}γ_{z}O, wherein:
α is at least one element selected from the group consisting of boron (B), aluminum (Al), gallium (Ga), indium (In), thallium (Tl), and combinations thereof,
β is at least one element selected from the group consisting of beryllium (Be), magnesium (Mg), calcium (Ca), strontium (Sr), barium (Ba), and combinations thereof,
γ is at least one element selected from the group consisting of copper (Cu), silver (Ag), gold (Au), and combinations thereof,
a ratio of x:y is at least about 1.0 and no more than about 6.2,
a ratio of x:z, when γ is present, is at least about 1.0 and no more than about 19.0, and
at least about 25% of active nickel sites in the catalyst composition are in a metallic state; and
(b) contacting, at a temperature of at least about 500° C. and no more than about 800° C., the catalyst composition with a reactant gas stream comprising methane gas.

33. The method of claim 32, wherein α is aluminum (Al).

34. The method of claim 32, wherein β is magnesium (Mg).

35. The method of claim 32, wherein γ is copper (Cu).

36. The method of claim 32, wherein a ratio of w:x is at least about 0.1 and no more than about 0.5.

37. The method of claim 32, wherein the ratio of x:y is at least about 1.8 and no more than about 2.8.

38. The method of claim 32, wherein the ratio of x:z, when γ is present, is at least about 2.3 and no more than about 9.0.

39. The method of claim 32, wherein at least about 50% of active nickel sites in the catalyst composition are in the metallic state.

40. The method of claim 32, wherein at least about 25% of active sites of the γ element(s) in the catalyst composition are in a metallic state.

41. The method of claim 40, wherein at least about 50% of active sites of the γ element(s) in the catalyst composition are in the metallic state.

42. The method of claim 32, wherein at least about 85% by mass of the carbon solids are formed as graphitic nanofibers comprising platelets aligned perpendicular to a fiber axis.

43. The method of claim 32, wherein the product stream is free of carbon monoxide.

44. The method of claim 32, wherein the reactant gas stream comprises at least about 99.9 vol % methane.

45. The method of claim 32, wherein the reactant gas stream further comprises at least about 5 vol % and no more than about 50 vol % hydrogen gas.

46. The method of claim 32, wherein the reactant gas stream further comprises carbon dioxide.

47. The method of claim 46, wherein the reactant gas stream is a stream of biogas or purified biogas.

48. The method of claim 32, wherein the temperature in step (b) is at least about 600° C. and no more than about 750° C.

49. The method of claim 48, wherein the temperature in step (b) is at least about 650° C. and no more than about 725° C.

50. The method of claim 32, wherein step (b) is performed in a suspended bed reactor.

51. The method of claim 32, wherein at least a portion of the elemental carbon solids form on surfaces of particles of the catalyst composition.
